(19) United States
(12) Patent Application Publication
(10) Pub. No.: US 2005/0191057 A1
(43) Pub. Date: Sep. 1, 2005

(54) Optical transceiver module

(75) Inventors: Ken-ichi Nakamoto, Kawasaki (JP); Tamotsu Akashi, Kawasaki (JP); Kazuyuki Mori, Kawasaki (JP); Shin-ichi Sakuramoto, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/871,038

(22) Filed: Jun. 21, 2004

(30) Foreign Application Priority Data
Feb. 27, 2004 (JP) 2004-053758

(51) Int. Cl. H04B 10/00

(52) U.S. Cl. 398/135

(57) ABSTRACT

An optical transceiver module is constituted so as to have an optical transmission module, an optical receiving module, a drive circuit board for driving the optical transmission module and the optical receiving module, and short-circuit means which induces an electrical short circuit between housings of the respective modules or induces an electrical short circuit between ground (GND) terminals of the respective modules on the module sides with respect to the drive circuit board. As a result, in the optical transceiver module, stray capacitance and stray inductance in lead pins, housings, and internal components of optical devices, such as an LD and a PD, are removed, thereby suppressing fluctuations in the potential (GND) of an LD housing which arise during high-frequency driving operation, as well as considerably suppressing electrical crosstalk between the transmission and receiving modules.

### BACKGROUND OF THE INVENTION

(1) Field of the Invention

The present invention relates to an optical transceiver module, and more particularly, to a technique suitable for use in a compact optical transceiver module in which components (e.g., an LD, a PD, and a circuit board) to be used for optical fiber communication are integrally constituted and which is subjected to high-frequency driving.

(2) Description of the Related Art

In a conventional optical transceiver module whose transmission speed is low [1.0 Gbps (gigabits/second) or less], electrical crosstalk arising between a transmission section and a receiving section can be lessened by means of upgrading a GND (ground) on a drive circuit board. However, in a high-frequency range in which the transmission speed exceeds 1.0 Gbps, a GND potential becomes greatly deviated from an ideal potential because of parasitic effects, such as stray capacitance and stray inductance of lead pins, housings, and internal components of optical devices, such as a laser diode (LD) and a photodiode (PD).

For this reason, the potential of a housing (i.e., GND) of the LD is liable to fluctuations during high-frequency driving operation, whereby electrical crosstalk develops between the transmission and receiving sections (i.e., the LD and the PD). For this reason, in relation to a surface-package-type optical module in which LD elements and PD elements are mounted directly on a board, there is a known technique (see Patent Document 1 provided below), wherein an Si substrate of low resistance is used for the board; and wherein the board is connected to a GND, thereby suppressing occurrence of crosstalk between the transmission and receiving sections. However, no decisive measures have been taken in connection with an optical transceiver module which is chiefly typified by a CAN-type optical transceiver module and in which an LD module and a PD module are formed integrally.

Regarding the Principle on which Crosstalk Arises

FIG. 10 is a diagrammatic perspective view showing the configuration of a conventional CAN-type optical transceiver (comprising an LD and a PD) module. FIG. 11 is a diagrammatic front view of the optical transceiver module when viewed in the direction of arrow A shown in FIG. 10. As shown in FIGS. 10 and 11, the conventional CAN-type optical transceiver module comprises a laser diode (LD) module (an optical transmission module) 100 and a photodiode (PD) module (an optical receiving module) 200, which are separate from each other. The optical transceiver module is constituted as a result of the modules 100, 200 being connected closely to a circuit board 300.

As shown in, e.g., FIG. 12, the LD module 100 incorporates an LD 111 and a PD 112 to be used for monitoring output light power and has, as external connection terminals, a GND terminal 101 [a housing (metal case) of the LD module 100]; an LD anode (PD cathode) terminal 102; an LD cathode terminal 103; and a PD anode terminal 104. A PD module 200 incorporates a PD 211 and a preamplifier 212 and has, as external connection terminals, a PD reverse bias voltage terminal 201, a preamplifier source voltage terminal 202, a positive(+) output terminal 203, a negative (−) output terminal 204, and a GND terminal 205 [a housing (metal case) of the PD module 200].

As shown in FIGS. 10, 11, and 12, the LD module 100 is connected to LD connection terminals 311 to 314 provided on the circuit board 300, by means of LD lead pins 411 to 414. The PD module 200 is connected to PD connection terminals 321 to 325 provided on the circuit board 300, by means of PD lead pins 421 to 425. These connections are realized by means of, e.g., soldering or the like. The lead pins 411 to 414 and 421 to 425 are omitted from FIG. 11. In FIGS. 10 and 11, reference numerals 512 to 514 denote hole sections formed in the housing of the LD module 100 (hereinafter also described as an “LD housing 100”), and reference numerals 521 to 524 denote hole sections formed in the housing of the PD module 200 (hereinafter also described as a “PD housing 200”).

The above-described connections will be described in more detail. The LD housing (metal case) 100 (the GND terminal 101) is connected to the LD connection terminal (a GND terminal) 311 provided on the circuit board 300, by means of the LD lead pin (GND lead pin) 411. The LD anode (the PD cathode) terminal 102 is connected to the LD connection terminal 312 provided on the circuit board 300, through the hole section 512 formed in the LD housing 100 and by means of the LD lead pin (LD anode lead pin) 412. The LD cathode terminal 103 is connected to the LD connection terminal 313 provided on the circuit board 300, through the hole section 513 of the LD housing 100 and by means of the LD lead pin (LD cathode lead pin) 413. The PD anode terminal 104 is connected to the LD connection terminal 314 provided on the circuit board 300, through the hole section 514 of the LD housing 100 and by means of the LD lead pin (PD anode lead pin) 414.

The PD reverse bias voltage terminal 201 is connected to the PD connection terminal 321 provided on the circuit board 300, through the hole section 521 of the PD housing 200 and by means of the PD lead pin (PD bias lead pin) 421. The preamplifier source voltage terminal 202 is connected to the PD connection terminal 322 provided on the circuit board 300, through the hole section 522 of the PD housing 200 and by means of the PD lead pin (a preamplifier source voltage lead pin) 422. The positive output terminal 203 is connected to the PD connection terminal 323 provided on the circuit board 300, through the hole section 523 of the PD housing 200 and by way of the PD lead pin (a PD positive output lead pin) 423. The negative output terminal 204 is connected to the PD connection terminal 324 provided on the circuit board 300, through the hole section 524 of the PD housing 200 and by means of the PD lead pin (a PD negative output lead pin) 424. The PD housing (metal case) 200 (the GND terminal 205) is connected to the PD connection terminal (GND terminal) 325 provided on the circuit board 300, by means of the PD lead pin (GND lead pin) 425.

Schemes for modulating the LD 111 include an external modulation scheme involving attachment of an external modulator, and an LD direct modulation scheme. The LD module 100 typified by a CAN-type LD module to be used for a compact optical transceiver module usually employs the LD direct modulation scheme, because of dimensional limitations. According to this LD direct modulation scheme, a voltage to be applied to the LD cathode terminal 103 is maintained constant, and the voltage to be applied to the LD anode terminal 102 is modulated by means of an LD driver (not shown) provided on the circuit board 300, thereby modulating the light output from the LD 111. At this time, modulation of the LD anode voltage induces fluctuations in the GND potential. The fluctuations are coupled with the PD module 200 as noise, thereby inducing crosstalk. This will be described in more detail hereunder.

Stray capacitance inherently exists between the LD lead pin (GND lead pin) 411 for connecting together the GND terminals 101, 311 and the LD lead pin (an LD anode lead pin) 412 to be connected to the LD anode (the PD cathode) terminal 104, and an impedance of ½ πfC is observed. Here, reference symbol “f” denotes a frequency (Hz); and C denotes stray capacitance (F). As the transmission speed increases, the frequency “f” increases; impedance approaches 0, i.e., a short circuit; and fluctuations in the GND potential attributable to modulation of the LD anode voltage become more intense. Therefore, the fluctuations in the GND potential and crosstalk are understood to become greater as the transmission speed increases.

The housing of the LD module 100 and that of the PD module 200 are short-circuited by way of the GND lead pins 411 and 425 and the GND terminals 311 and 325 of the circuit board 300, to thus act as a common GND. However, stray inductance inherently exists in various lead pins of optical devices and the housings, both belonging to the LD and PD modules 100, 200, and patterns provided on the circuit board 300, and an impedance of 2 πfL is observed. Here, reference symbol “f” denotes a frequency (Hz); and L denotes stray inductance (H).

Therefore, as the transmission speed increases, the frequency “f” also increases; the impedance approaches infinity (∞), i.e., an open state; and the GND potential deviates from an ideal GND whose potential is stable, wide, and flat. Therefore, it is understood that the GND potential becomes unstable with an increase in transmission speed and that the fluctuations in the GND potential and the crosstalk become greater.

A conceivable propagation mode of crosstalk includes spatial coupling of fluctuations (noise) in the potential of the LD housing (GND) potential with the PD housing (GND) by way of an antenna and coupling of the fluctuations to the PD housing by way of a GND pattern provided on the board.

In order to eliminate a parasitic effect in a packaged high-frequency electronic device, a technique for short-circuiting high-frequency stray capacitance by means of coupling a capacitor of high capacitance as closely as possible to an anode located between a metal housing and an anode lead wire has hitherto been put forward in Patent Document 2 provided below (see FIGS. 4 and 5 of Patent Document 2).

[Patent Document 1] JP-A-2001-210841

[Patent Document 2] JP-A-2002-324866

As has been described, in the compact optical transceiver module in which the LD module 100, the PD module 200, and the circuit board 300 are integrated together, the transmission section and the receiving section are located very closely to each other, and mutual interference between the transmission and receiving sections becomes greater at the time of high-frequency driving. The transmission and receiving sections are susceptible to the influence of noise. For these reasons, electrical crosstalk developing between the transmission and receiving sections is great, which is responsible for deterioration of receiving sensitivity. It is also possible to form a GND pattern for the transmission section and that for the receiving section separately on the circuit board (i.e., so as not to share a common GND) and separate the GND patterns from each other, to thus diminish the electrical crosstalk. However, a distance of about 1 cm is required at 2.4 Gbps, and hence it is considered that this optical transceiver module cannot be implemented through use of a current compact optical transceiver module.

During high-frequency driving operation, high-frequency noise deriving from the high-frequency driving operation also induces deterioration of the waveform of the light output from the transmission section. The technique described in Patent Document 2 enables short-circuiting of stray capacitance existing between the metal housing and the anode lead wire in connection with only the LD module 100 (or the PD module 200). However, the technique fails to suppress the electrical crosstalk developing between the transmission and receiving sections of the optical transceiver module in which the LD module 100, the PD module 200, and the circuit board 300 are formed integrally.

### SUMMARY OF THE INVENTION

The present invention has been conceived in view of such a problem and aims at enabling a significant reduction in electrical crosstalk developing between transmission and receiving sections, by means of eliminating stray capacitance and stray inductance in lead pins, housings, and internal components of optical devices, such as an LD and a PD; and suppressing fluctuations in an LD housing (GND) potential which arise during high-frequency driving operation.

In order to achieve the object, an optical transceiver module of the present invention is characterized by comprising: an optical transmission module; an optical receiving module; a drive circuit board for driving the optical transmission module and the optical receiving module; and short circuit means which induces an electrical short circuit between housings of the respective modules or induces an electrical short circuit between ground terminals of the respective modules on the modules' sides with respect to the drive circuit board.

Here, the optical transmission module may be configured so as to have a laser diode (LD) having at least an anode terminal, a cathode terminal, and a ground(GND) terminal, and the optical receiving module may be configured so as to have a photodiode (PD) having at least a ground(GND) terminal.

Moreover, the short circuit means is preferably formed from a module package board having through holes, wherein the optical transmission module and the optical receiving module are mounted on one surface of the board and a ground(GND) pattern is formed on the other surface of the board, and ground(GND) terminals of the laser diode and the photodiode are preferably connected to the ground(GND) pattern formed on the other surface of the module package board from the one surface by way of the through holes.

A bypass capacitor may be provided between the anode terminal provided in the vicinity of the laser diode and the ground (GND) pattern on the module package board. Alternatively, an RC filter formed by connecting a resistor and a capacitor in series with each other may be interposed between the anode terminal and the cathode terminal of the laser diode, both being located in the vicinity of the laser diode on the module package board.

According to the present invention, a circuit located between the optical transmission module and the optical receiving module is electrically short-circuited. Accordingly, stability of the GND potential of an optical device, such as an LD and a PD, can be enhanced. The influence of stray capacitance and stray inductance existing in the lead pins, the housings, and the internal components of the optical devices can be suppressed. Consequently, fluctuations in the LD housing (GND) potential, which arise during the high-frequency driving operation, can be suppressed, thereby significantly suppressing the electrical crosstalk developing between the transmission and receiving sections.

### BRIEF DESCRIPTION OF THE DRAWINGS

FIG. 1 is a diagrammatic perspective view showing the configuration of an optical transceiver module serving as a first embodiment of the present invention;

FIG. 2 is a diagrammatic front view of the optical transceiver module when viewed in a direction of arrow A shown in FIG. 1;

FIG. 3 is a diagrammatic front view showing a modification of a connection between an LD and a PD shown in FIGS. 1 and 2;

FIG. 4 is a diagrammatic perspective view showing the configuration of an optical transceiver module serving as a second embodiment of the present invention;

FIG. 5 is a diagrammatic front view of the optical transceiver module when viewed in a direction of arrow A shown in FIG. 4;

FIG. 6 is a diagrammatic front view showing the configuration of a first modification of the optical transceiver module described by reference to FIGS. 4 and 5;

FIG. 7 is a diagrammatic front view showing the configuration of a second modification of the optical transceiver module described by reference to FIGS. 4 and 5;

FIG. 8A is a diagrammatic perspective view for describing the configuration of an optical transceiver module serving as a third modification of the second embodiment, showing the configuration of a sub-board;

FIG. 8B is a diagrammatic perspective view for describing the configuration of the optical transceiver module serving as the third modification of the second embodiment, showing the configuration of connection hardware;

FIG. 8C is a diagrammatic perspective view for describing the configuration of the optical transceiver module serving as the third modification of the second embodiment, showing the configuration of the optical transceiver module;

FIG. 9 is a block diagram showing the configuration of an optical transceiver module serving as an integrated device formed by fixing an LD housing and a PD housing through use of a single metallic housing;

FIG. 10 is a diagrammatic perspective view showing the configuration of a conventional CAN-type optical transceiver (comprising an LD and a PD) module;

FIG. 11 is a diagrammatic front view of the optical transceiver module when viewed in the direction of arrow A shown in FIG. 10; and

FIG. 12 is an electrical circuit diagram of the conventional optical transceiver module shown in FIGS. 10 and 11.

### DESCRIPTIONS OF THE PREFERRED EMBODIMENTS

[A] Descriptions of a First Embodiment

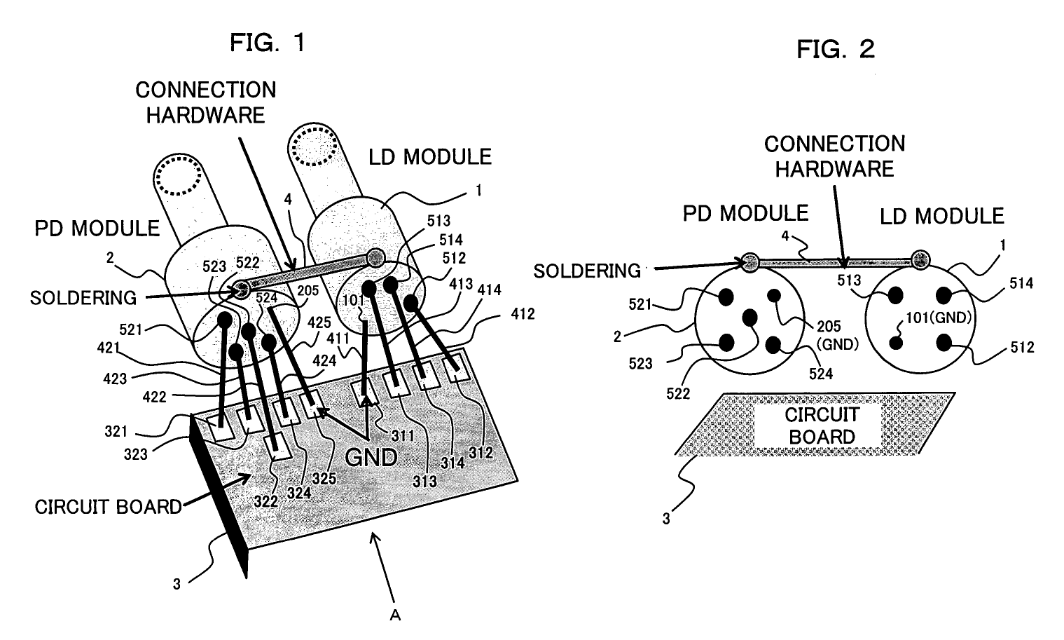

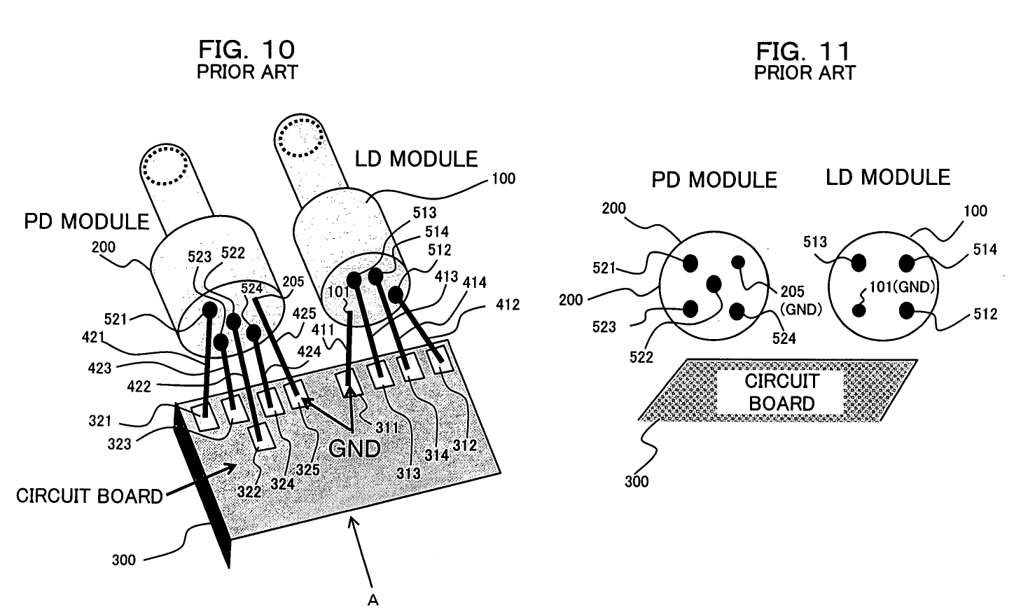

FIG. 1 is a diagrammatic perspective view showing the configuration of an optical transceiver module serving as a first embodiment of the present invention. FIG. 2 is a diagrammatic front view of the optical transceiver module when viewed in a direction of arrow A shown in FIG. 1. As shown in FIGS. 1 and 2, the optical transceiver module of the present invention comprises a CAN-type LD module 1 which has an LD (a light-emitting element) provided in a cylindrical metal housing and acts as an optical transmission module; a CAN-type PD module 2 which has a PD (a light-receiving element) provided in a cylindrical metal housing and acts as an optical receiving module; and a circuit board (a drive circuit board) 3 for driving the LD module 1 and the PD module 2. In the same manner as in the case of the optical transceiver module described by reference to FIGS. 10 and 11, the LD module 1 is connected to the circuit board 3 (LD connection terminals 311 to 314) by means of LD lead pins (lead wires) 411 to 414; and the PD module 2 is connected to the circuit board 3 (PD connection terminals 321 to 325) by means of PD lead pins (lead wires) 421 to 425.

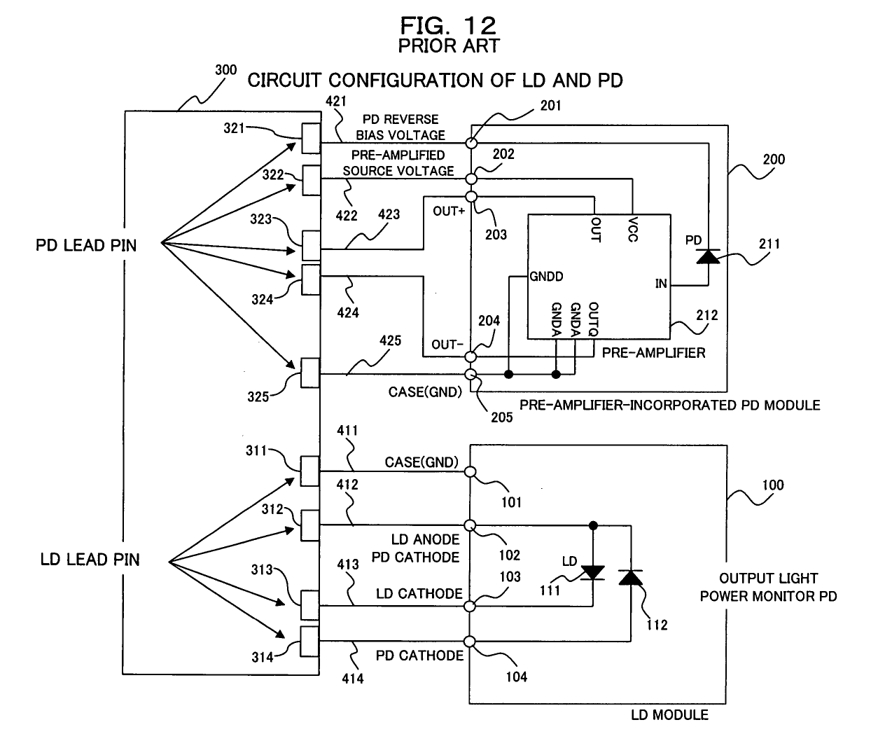

Here, the internal configurations of the LD and PD modules 1, 2 are the same as those described by reference to FIG. 12, and electrical connections between the LD and PD modules 1, 2 and the circuit board 3 are also the same as those described by reference to FIG. 12.

Specifically, a housing of the LD module 1 (hereinafter also called an “LD housing 1” or “LD metal housing 1”) (a GND terminal 101) is connected to the LD connection terminal (GND terminal) 311 provided on the circuit board 3 by means of the LD lead pin (GND lead pin) 411. An LD anode (PD cathode) terminal 102 is connected to the LD connection terminal 312 provided on the circuit board 3, through a hole section 512 of the LD housing 1 and by means of the LD lead pin (LD anode lead pin) 412. An LD cathode terminal 103 is connected to the LD connection terminal 313 provided on the circuit board 3, through a hole section 513 of the LD housing 1 and by means of the LD lead pin (LD cathode pin) 413. A PD anode terminal 104 is connected to the LD connection terminal 314 provided on the circuit board 3, through a hole section 514 of the LD housing 1 and by means of the LD lead pin (PD anode lead pin) 414.

A PD reverse bias voltage terminal 201 is connected to the PD connection terminal 321 provided on the circuit board 3, through a hole section 521 of a housing of the PD module 2 (hereinafter also called a “PD housing 2” or “PD metal housing 2”) and by means of the PD lead pin (PD bias lead pin) 421. A source voltage terminal 202 is connected to the PD connection terminal 322 provided on the circuit board 3, through a hole section 522 of the PD housing 2 and by means of the PD lead pin (preamplifier source voltage lead pin) 422. A positive (+) output terminal 203 is connected to the PD connection terminal 323 provided on the circuit board 3, through a hole section 523 of the PD housing 2 and by means of the PD lead pin (a PD positive output lead pin) 423. A negative output terminal 204 is connected to the PD connection terminal 324 provided on the circuit board 3, through a hole section 524 of the PD housing 2 by means of the PD lead pin (PD negative output lead pin) 424. The PD housing 2 (a GND terminal 205) is connected to the PD connection terminal (GND terminal) 325 provided on the circuit board 3, by means of the PD lead pin (GND lead pin) 425.

Unless otherwise specified, the connections remain identical in embodiments which will be described later. The number and applications of the respective lead pins are not limited to those mentioned above (the internal configuration of the optical transmission module 1 and that of the optical receiving module 2 may differ from those mentioned previously).

As shown in FIGS. 1 and 2, in the present embodiment, the LD metal housing 1 and the PD metal housing 2 are connected and short-circuited by means of LD-PD connection hardware (short-circuiting means) 4. This connection is formed by means of, e.g., soldering or the like. When the connection hardware 4 is formed in a shape such that the hardware is latched on the GND lead pins 411, 425, ease of attachment work is improved. Even when the metal housings are connected through use of lead wires, a similar configuration will be adopted.

The LD housing 1 and the PD housing 2 are originally short-circuited by way of the GND lead pins 411 and 425 (the GND terminals 101 and 205) and the GND terminals 311 and 325 of the circuit board 3, to thus act as a common GND. Lead pins, housings, and internal components of optical devices typified by a CAN-type optical device, such as an LD and a PD, generate stray capacitance and stray inductance, which are usually greatly deviated from an ideal GND potential. For this reason, as mentioned previously, the GND potential is subjected to fluctuations during the high-frequency driving operation.

As mentioned above, the stray inductance developing during the high-frequency driving operation is reduced by means of inducing an electrical short circuit between the LD housing 1 and the PD housing 2 through use of connection hardware, thereby enhancing GND. As a result, the GND potential can be made close to an ideal GND potential, thereby suppressing fluctuations in the GND potential which arise during the high-frequency driving operation. Electrical crosstalk developing between the respective modules 1, 2 (i.e., between the transmission and receiving sections) can be diminished significantly. Particularly, stabilization of the potential (GND) of the LD housing 1 yields a great effect of suppressing crosstalk.

A material which is as wide as possible and has a large contact area is used as the connection hardware 4, instead of a line-shaped material such as a lead wire. Use of a material which increases the contact area between the modules 1, 2 and the connection hardware 4 yields a greater effect of making the GND potential stable and suppressing crosstalk.

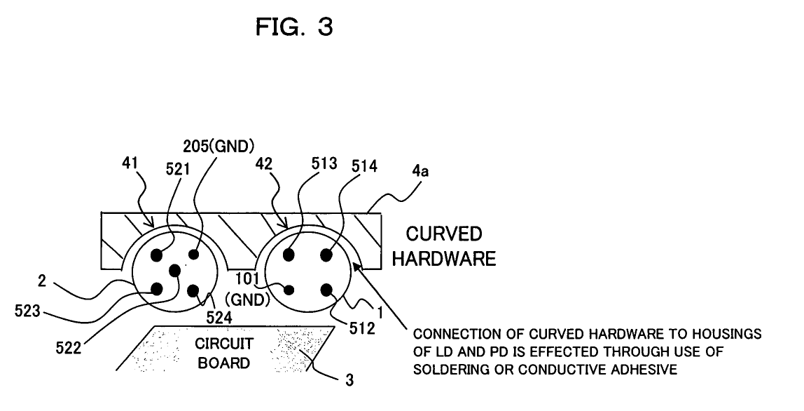

As diagrammatically shown in, e.g., FIG. 3, a greater effect of stabilizing a GND potential and suppressing crosstalk can be obtained, so long as the following configuration is adopted. Specifically, semi-circular depression sections 41, 42 are formed in one surface of flat hardware 4a with curves in conformance to a distance between the modules 1, 2 and shapes of upper curved surfaces of the respective modules (cylindrical housings) 1, 2. The curved hardware 4a is fitted to the modules 1, 2 from the top and fixedly brought into intimate contact with the modules 1, 2 with solder, a conductive adhesive, or the like, thereby forming a short circuit between the modules (housings) 1, 2. The shape of the hardware 4a (i.e., the depression sections 41, 42) can be changed in conformance to the shapes of the modules (housings) 1, 2, as required.

[B] Descriptions of a Second Embodiment

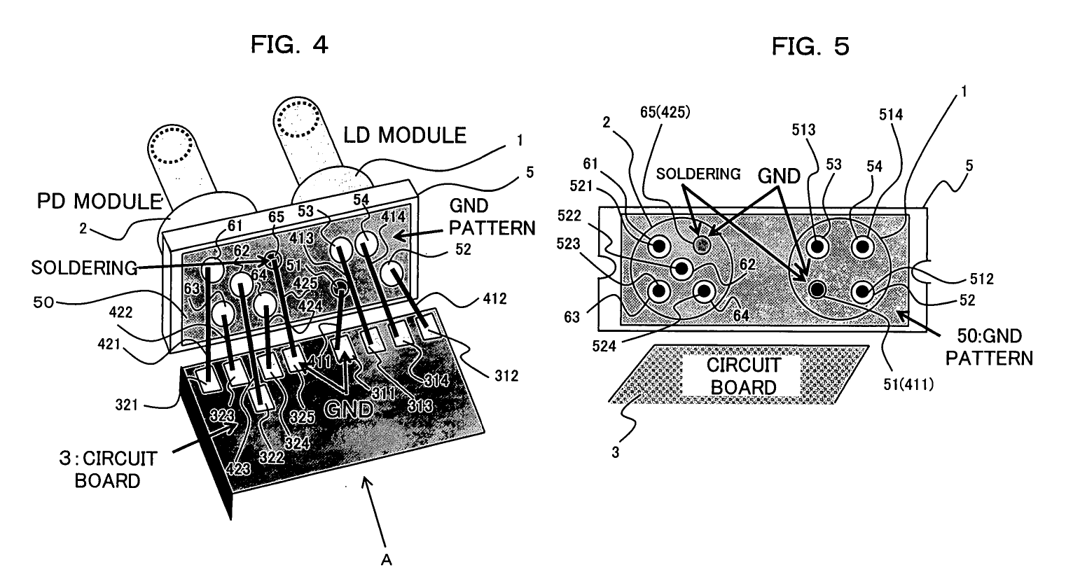

FIG. 4 is a diagrammatic perspective view showing the configuration of an optical transceiver module serving as a second embodiment of the present invention, and FIG. 5 is a diagrammatic front view of the optical transceiver module when viewed in a direction of arrow A shown in FIG. 4. As shown in FIGS. 4 and 5, the optical transceiver module of the present invention comprises the CAN-type LD module 1; the CAN-type PD module 2; the circuit board (drive circuit board) 3; and another circuit board (sub-circuit board) 5.

The modules 1, 2 are mounted on one surface of the sub-board (module mount board) 5. Formed in the other surface of the sub-board are hole sections (through holes) 51 to 54 and 61 to 65 for use with (and which are aligned with) the lead pins 411 to 414 and 421 to 425 of the respective modules 1, 2. A GND pattern 50 having a wide area is formed over the entirety or substantially the entirety of other surface of the sub-board so as to avoid the through holes 51 to 54 and 61 to 65.

The lead pins 411 to 414 and 421 to 425 are connected to the corresponding connection terminals 311 to 315 and 321 to 325 provided on the circuit board 3, by way of the corresponding through holes 51 to 54 and 61 to 65. The GND lead pins 411 and 425 (the GND terminals 101 and 205) are also connected (bonded) respectively to the GND pattern 50 formed on the other surface of the sub-board 5 by way of the through holes formed therein, by means of soldering or the like. Even in the present embodiment, the electrical connections between the internal configurations of the modules 1, 2 and the circuit board 3 are the same as those described previously by reference to FIG. 12.

As a result of adoption of such a configuration, the GND lead pins 411 and 425 (i.e., the GND terminals 101 and 205) of the respective modules 1, 2 are connected to the GND pattern 50 that is formed on the sub-board 5 and has a wide area, thereby forming a connection (short circuit) between the modules 1, 2. Namely, the sub-board 5 of the present embodiment acts as short-circuit means for forming an electrical short circuit between the GND terminals 101 and 205 of the respective modules 1, 2; that is, between the modules 1, 2, in relation to the circuit board 3. Therefore, an attempt can be made to render the GND potential very stable, thereby yielding a significant effect of suppressing crosstalk. Moreover, as a result of use of the sub-board 5 such as that mentioned previously, assembly of the optical transceiver module is facilitated, thereby greatly contributing to cutting of costs for manufacturing the optical transceiver module.

Even in the present embodiment, the housings of the respective modules 1, 2 may be short-circuited, as in the case of the first embodiment.

(B1) Descriptions of a First Modification

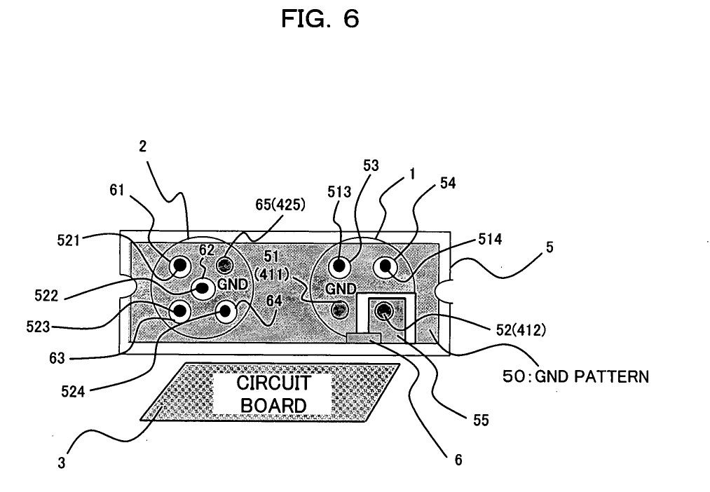

FIG. 6 is a diagrammatic front view showing the configuration of a first modification of the optical transceiver module described by reference to FIGS. 4 and 5. In the optical transceiver module shown in FIG. 6, an electrode section 55 (LD anode electrode pattern) to be used for use with the LD anode lead pin 412 (LD anode terminal 102) of the LD module 1 is formed on the sub-board 5. The GND pattern 50 having a wide area is formed on the entirety or substantially the entirety of the other surface of the sub-board so as to avoid the through holes 51 to 53 and 61 to 65.

The LD anode lead pin 412 is connected to the LD anode electrode pattern 55 by means of soldering or the like. Even in this case, the GND lead pins 411, 425 of the respective modules 1, 2 passing through the through holes 51, 65 of the sub-board 5 are connected to the GND pattern 50 by means of soldering or the like, whereby the respective modules (metal cases) 1, 2 are connected (short-circuited). As shown in FIG. 6, a bypass capacitor 6 is interposed between the LD anode electrode pattern 55 and the GND pattern 50.

The bypass capacitor 6 causes excessive high-frequency components (noise components) existing in the LD anode terminal 102 to flow to the GND. In general, the bypass capacitor is originally mounted on the circuit board 3. If the bypass capacitor is disposed separately from the LD 111 (see FIG. 12), the capacitance will not match with theoretical capacitance, for reasons of stray inductance and stray capacitance existing in the patterns laid between the bypass capacitor and the LD 111 on the circuit board 3 and in the anode lead pin 412. Because of this influence, the bypass capacitor fails to exhibit the effect.

As mentioned above, as a result of provision of the LD anode lead pin 412 (LD anode electrode pattern 55) and the GND lead pin 411 (the GND pattern 50 of the sub-board 5), the bypass capacitor 6 can be placed in the vicinity of the LD 111 (a location which is as close as possible to the root of the anode lead pin 414), whereby the effect of the bypass capacitor can be yielded.

The bypass capacitor 6 extracts the excessive high-frequency components from the LD anode voltage components and bypasses the thus-extracted components to the GND pattern 50. Therefore, fluctuations in the GND potential induced by the LD anode voltage during the high-frequency driving operation are diminished, thereby suppressing the electrical crosstalk developing between the LD and the PD (between the transmission and receiving sections). Particularly, in the present embodiment, an attempt is made to render the GND potential stable by means of placing the wide GND pattern 50 on the sub-board 5 and short-circuiting the modules 1, 2. Therefore, a considerably large effect is yielded. Moreover, the chance of other crosstalk being induced by the bypassed high-frequency noise is very small. The excessive high-frequency components can be eliminated from the LD anode voltage components, thereby achieving an improvement in a modulated optical output waveform.

The bypass capacitor 6 does not necessarily need to be provided on the sub-board 5. In a case where the sub-board 5 is not used, the essential requirement is that the bypass capacitor 6 be placed in the vicinity of the LD 111.

(B2) Descriptions of a Second Modification

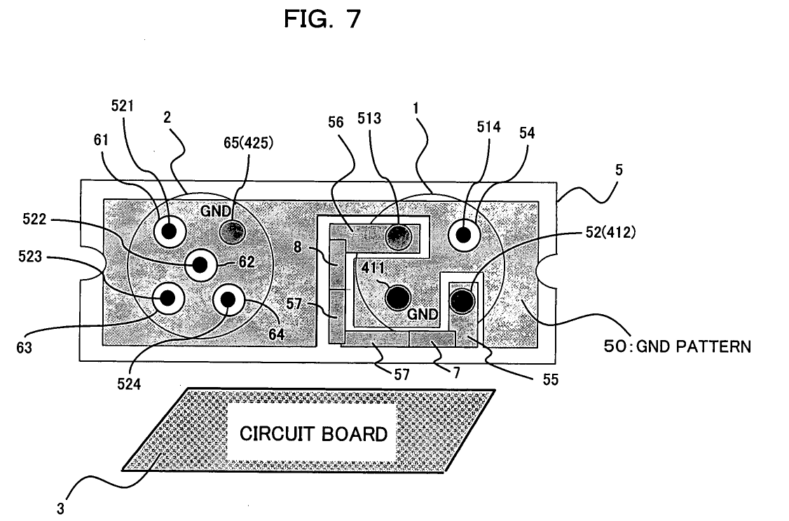

FIG. 7 is a diagrammatic front view showing the configuration of a second modification of the optical transceiver module described by reference to FIGS. 4 and 5. In the optical transceiver module shown in FIG. 7, provided on the sub-board 5 are the LD anode electrode pattern 55; an electrode section 56 (LD cathode electrode pattern) to which the LD cathode lead pin 513 (LD cathode terminal 103) is to be connected by means of soldering or the like; an electrode pattern 57 to be used for connecting the LD anode electrode pattern 55 to the LD cathode electrode pattern 56; a capacitor 7 interposed between the LD anode electrode pattern 55 and the electrode pattern 57 by means of soldering or the like; a resistor 8 interposed between the LD cathode electrode 56 and the electrode pattern 57 by means of soldering or the like; and the GND pattern 50 formed so as to avoid the electrode patterns 55, 56, 57, the capacitor 7, and the resistor 8.

In the present embodiment, an RC filter formed by means of connecting the capacitor 7 and the resistor 8 in series is interposed between the LD anode lead pin 412 and the LD cathode lead pin 413 on the sub-board 5. The RC filter is used for the purpose of changing a rise time or fall time of a modulated voltage applied to the LD anode terminal 102 by means of adjusting a time constant of the RC filter. Usually, this RC filter is also originally mounted on the circuit board 3, as in the case of the bypass capacitor. If the RC filter is disposed separately from the LD 111 (see FIG. 12), the time constant of the RC filter will fail to match a theoretical time constant, and the RC filter will fail to exhibit an effect. For this reason, the electrode patterns 55, 56, 57, the capacitor 7, and the resistor 8 are disposed on the sub-board 5 and connected together, whereby the RC filter can be placed in the vicinity of the LD 111 (a place which is as close as possible to the roots of the lead pins 412, 414). Thus, distortion in the modulated optical output waveform can be improved to a much greater extent.

Even in this case, the RC filter does not necessarily need to be placed on the sub-board 5. In a case where the sub-board 5 is not used, the essential requirement is that the RC filter be placed in the vicinity of the LD 111.

(B3) Descriptions of a Third Modification

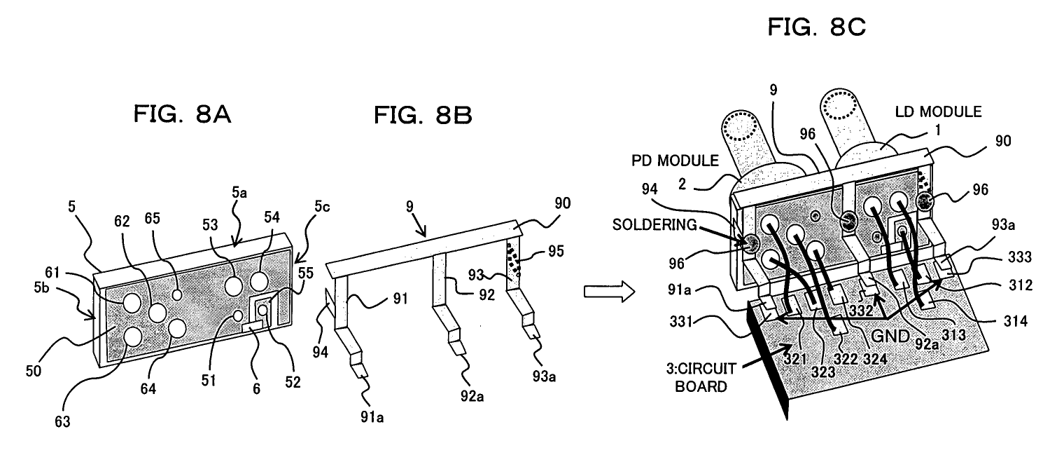

FIGS. 8A to 8C are a diagrammatic perspective views for describing the configuration of an optical transceiver module serving as a third modification of the second embodiment. Namely, FIG. 8A shows the configuration of a sub-board; FIG. 8B shows the configuration of connection hardware; and FIG. 8C shows the configuration of the optical transceiver module.

As shown in FIG. 8A, the sub-board 5 is equipped with the bypass capacitor 6 described by reference to, e.g., FIG. 6. Alternatively, the sub-board 5 that has been described by reference to FIGS. 4 and 5 or FIG. 7 may be applied to this modification.

Connection hardware 9 shown in FIG. 8A comprises a contact section 90 to come into contact with one longer side surface 5a of the sub-board 5; leg sections 91, 92, and 93 formed stepwise; and contact sections 94, 95 which are provided at respective ends of leg sections 91, 93 and come into contact with shorter side surfaces 5b, 5c. The leg sections 91, 92, and 93 are preferably formed so as to have a certain width (area) rather than in the form of a line, in order to suppress stray capacitance and stray inductance.

As shown in FIG. 8C, GND terminals (GND patterns) 331, 332, and 333 are provided on the circuit board 3 in the vicinity of respective ends thereof and at the center of the same so as to correspond to the respective leg sections 91, 92, and 93. After contact sections 90, 94, and 95 of the connection hardware 9 have been brought into latched contact with the respective side surfaces 5a, 5b, 5c of the sub-board 5, the leg sections 91, 92, and 93 are connected to the GND pattern 50 on the sub-board 5 by means of solder 96 or the like, thereby achieving integration. End sections 91a, 92a, and 93a of the respective leg sections 91, 92, and 93 are connected to the GND terminals 331, 332, and 333 by means of soldering or the like. As a result, the LD module 1, the PD module 2, the circuit board 3, and the sub-board 5 can be integrally constituted.

In this case, the GND terminals 331, 332, 333 provided on the circuit board 3 are connected to the GND pattern 50 provided on the sub-board 5 by means of the leg sections 91, 92, and 93 of the connection hardware 9. Accordingly, the connection between the GND lead pins 411 and 425 (see, e.g., FIG. 4) and the circuit board 3 is obviated. Specifically, the connection hardware 9 of the present embodiment acts as the connection (i.e., the short circuit) between the LD housing 1 and the PD housing 2 and also as the GND connection between the housings 1, 2 and the circuit board 3.

Consequently, the efficiency of assembling operation required at the time of fabrication of the optical transceiver module through use of the sub-board 5 can be improved significantly, thereby enabling an attempt to further curtail the manufacturing costs of the optical transceiver module.

In the above-described embodiment, connection of the GND pattern 50 provided on the sub-board 5 with the respective leg sections 91, 92, and 93 is performed first. However, coupling of the end sections 91a, 92a, and 93a of the respective leg sections 91, 92, and 93 with the GND terminals 331, 332, and 333 provided on the circuit board 3 may be performed first. Further, in the present embodiment, only the bypass capacitor 6 is provided on the sub-board 5. However, the RC filter maybe disposed, or both the bypass capacitor 6 and the RC filter may be disposed.

The number of the leg sections of the connection hardware 9 is not limited to three as mentioned previously but may be changed as required. For instance, the LD housing 1 and the PD housing 2 may be connected together by means of only the two GND terminals 331, 333 disposed on the respective ends of the circuit board 3. In addition, in consideration of the efficiency of assembling operation and the influence of stray capacitance and stray inductance, a large increase in the number of the legs sections is considered to be not preferable. In the present embodiment, the GND terminals 331, 332, and 333 are provided on only one side of the circuit board 3. However, GND terminals can be provided on the other surface of the circuit board 3 or on both surfaces thereof.

The shape of the connection hardware 9 is not limited to that shown in FIG. 8B. The shape can be changed, if necessary, so long as the shape enables integration of the hardware with the sub-board 5, connection of the PD module 1 and the LD module 2 to GND, and connection of the PD and LD modules with the circuit board 3 through GND.

[C] Others

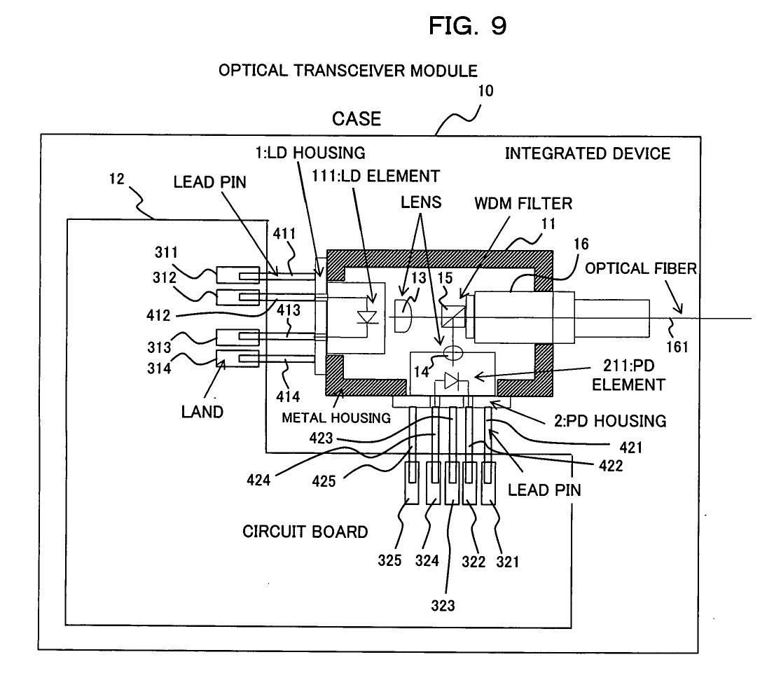

FIG. 9 is a block diagram showing the configuration of an optical transceiver module serving as an integrated device formed by fixing an LD housing and a PD housing through use of a single metallic housing. The optical receiving module shown in FIG. 9 comprises a case 10; and a metal housing 11 and a circuit board 12, both being housed in the case 10. The LD housing 1, the PD housing 2, equipped with a light-receiving lens 14, and a fiber connector 16, such as a ferrule, are fixedly fitted to the metal housing 11. The metal housing 11 further incorporates a lens 13 that couples the light output from the LD 111 to the fiber connector 16 connected to an optical fiber 161; and a WDM filter 15 for causing the PD 211 to receive light by means of coupling the light received through the optical fiber 161 to the light-receiving lens 14 of the PD housing 2.

The LD housing 1 is connected to the respective lands (LD connection terminals) 311 to 314 provided on the circuit board 12 by means of the lead pins 411 to 414. The PD housing 2 is connected to the lands (PD connection terminals) 321 to 325 provided on the circuit board 13 by means of the PD lead pins 421 to 425. The LD housing 1, the PD housing 2, and the metal housing 11 are connected together by means of primarily laser beam welding or the like.

Thus, the LD housing 1 and the PD housing 2 are short-circuited with the metal housing 11, and hence a working-effect similar to that achieved in the first embodiment can be obtained.

Needless to say, the present invention is not limited to the previously-described embodiments and can be practiced while being modified in various manners within the scope of the gist of the present invention.

For instance, the previous embodiments have described a configuration in which the LD module is applied to the optical transmission module and the PD module is applied to the optical receiving module. However, even when the present invention is applied to another optical module (device), a working-effect similar to that achieved in the previous embodiments can be obtained.

As has been described in detail, according to the optical transceiver module of the present invention, electrical crosstalk developing between the transmission and receiving modules during high-frequency driving operation can be suppressed significantly. Hence, the optical transceiver module of the invention is considered to be very useful in the field of an optical communications technique.

1. An optical transceiver module comprising:
an optical transmission module;
an optical receiving module;
a drive circuit board for driving said optical transmission module and said optical receiving module; and
short-circuit means which induces an electrical short circuit between housings of said respective modules or induces an electrical short circuit between ground terminals of said respective modules on said modules' sides with respect to said drive circuit board.

2. The optical transceiver module according to claim 1, wherein a housing of said optical transceiver module and a housing of said optical receiving module are connected together by means of a flat-shaped metal member serving as said short-circuit means.

3. The optical transceiver module according to claim 2, wherein said optical transmission module is configured so as to have a laser diode (LD) having at least an anode terminal, a cathode terminal, and a ground(GND) terminal; and
said optical receiving module is configured so as to have a photodiode (PD) having at least a ground(GND) terminal.

4. The optical transceiver module according to claim 1, wherein a housing of said optical trans mission module and a housing of said optical receiving module are each formed from a cylindrical housing;
there is provided, as said short-circuit means, a flat-shaped metal member having depression sections in one side thereof, said depression sections being formed in conformance to a distance between said cylindrical housings and curved shapes of said respective cylindrical housings; and
said cylindrical housings are fixedly fitted into said depression sections of said metal member.

5. The optical transceiver module according to claim 4, wherein said cylindrical housings and said depression sections are bonded together by means of solder or a conductive adhesive.

6. The optical transceiver module according to claim 4, wherein said optical transmission module is configured so as to have a laser diode (LD) having at least an anode terminal, a cathode terminal, and a ground(GND) terminal; and
said optical receiving module is configured so as to have a photodiode (PD) having at least a ground(GND) terminal.

7. The optical transceiver module according to claim 1, wherein said short-circuit means and said drive circuit board are ground(GND)-connected together.

8. The optical transceiver module according to claim 7, wherein said optical transmission module is configured so as to have a laser diode (LD) having at least an anode terminal, a cathode terminal, and a ground(GND) terminal; and
said optical receiving module is configured so as to have a photodiode (PD) having at least a ground(GND) terminal.

9. The optical transceiver module according to claim 1, wherein said optical transmission module is configured so as to have a laser diode (LD) having at least an anode terminal, a cathode terminal, and a ground(GND) terminal; and
said optical receiving module is configured so as to have a photodiode (PD) having at least a ground(GND) terminal.

10. The optical transceiver module according to claim 9, wherein said short-circuit means is formed from a module package board having through holes, in which said optical transmission module and said optical receiving module are mounted on one surface of said board and a ground(GND) pattern is formed on the other surface of said board; and
ground(GND) terminals of said laser diode and said photodiode are connected to said ground(GND) pattern formed on said other surface of said module package board from said one surface by way of said through holes.

11. The optical transceiver module according to claim 10, wherein a bypass capacitor is provided on said module package board at a position located in the vicinity of said laser diode and between said anode terminal and said ground(GND) pattern.

12. The optical transceiver module according to claim 10, wherein an RC filter formed by connecting a resistor and a capacitor in series with each other is provided on said module package board at a position located in the vicinity of said laser diode and between said anode terminal and said cathode terminal.

13. The optical transceiver module according to claim 10, wherein said ground(GND) pattern provided on said module package board and a ground(GND) terminal provided on said drive circuit board are connected with each other by means of a lead wire.

14. The optical transceiver module according to claim 10, wherein said ground(GND) pattern provided on said module package board and said ground(GND) terminal provided on said drive circuit board are connected with each other by means of connection hardware integrated with said module package board.

15. The optical transceiver module according to claim 10, wherein said module package board is formed from a rigid board or a flexible board.

16. The optical transceiver module according to claim 1, wherein a bypass capacitor which connects said anode terminal to said ground(GND) terminal of said laser diode is provided in the vicinity of said anode terminal of said laser diode.

17. The optical transceiver module according to claim 1, wherein an RC filter formed by connecting a resistor and a capacitor in series with each other is interposed between said anode terminal and said cathode terminal of said laser diode.
